(19) United States
(12) Patent Application Publication
(10) Pub. No.: US 2025/0267361 A1
(43) Pub. Date: Aug. 21, 2025

(54) AUTOFOCUS CONTROL APPARATUS, IMAGE PICKUP APPARATUS, AUTOFOCUS CONTROL METHOD, AND STORAGE MEDIUM

(71) Applicant: CANON KABUSHIKI KAISHA, Tokyo (JP)

(72) Inventor: TOYOKATSU FUJISAKI, Tochigi (JP)

(21) Appl. No.: 19/201,326

(22) Filed: May 7, 2025

Related U.S. Application Data
(63) Continuation of application No. PCT/JP2023/035930, filed on Oct. 2, 2023.

(30) Foreign Application Priority Data
Nov. 11, 2022 (JP) 2022-180703

(51) Int. Cl. H04N 23/67; H04N 25/773

(52) U.S. Cl. CPC H04N 23/673; H04N 25/773

(57) ABSTRACT

An autofocus control apparatus includes a processor configured to control a focus drive unit configured to drive a focus lens unit that is at least a part of an imaging optical system based on contrast information obtained from an image sensor that includes a plurality of photoelectric converters arranged on a two-dimensional plane, each of the plurality of photoelectric converters including a light receiver configured to convert light incident from the imaging optical system into a voltage pulse, and a counter configured to count the number of the voltage pulses. The processor is configured to cause the focus drive unit to reciprocate the focus lens unit while continuing exposure of the image sensor, and control the focus drive unit based on the contrast information of each of a plurality of images generated from the number of pulses of the voltage pulses generated within an exposure period of the exposure.

### CROSS-REFERENCE TO RELATED APPLICATIONS

This application is a Continuation of International Patent Application No. PCT/JP2023/035930, filed on Oct. 2, 2023, which claims the benefit of Japanese Patent Application No. 2022-180703, filed on Nov. 11, 2022, each of which is hereby incorporated by reference herein in their entirety.

### BACKGROUND

### Technical Field

The present disclosure relates to an autofocus control apparatus.

### Description of Related Art

In autofocus (AF) using contrast information, a direction in which to move the focus lens unit is determined by reciprocating a focus lens unit within a small range. Unlike the active method that irradiate an object with auxiliary light, this contrast detecting method can advantageously perform focusing without causing the object, such as an animal, to notice the photographer. However, since the contrast of the image is used, the focusing speed is lower than that in the method using triangulation. In addition, conventional cameras equipped with a CMOS or CCD have difficulty in acquiring a contrast difference in dark places, and the focusing accuracy is not high.

Japanese Patent Laid-Open No. 2003-262788 discloses an AF control apparatus that attempts to increase a focus control speed by changing a frame rate of a photoelectric converter according to the object luminance.

### SUMMARY

An autofocus control apparatus according to one aspect of the disclosure includes a processor configured to control a focus drive unit configured to drive a focus lens unit that is at least a part of an imaging optical system based on contrast information obtained from an image sensor that includes a plurality of photoelectric converters arranged on a two-dimensional plane, each of the plurality of photoelectric converters including a light receiver configured to convert light incident from the imaging optical system into a voltage pulse, and a counter configured to count the number of the voltage pulses. The processor is configured to cause the focus drive unit to reciprocate the focus lens unit while continuing exposure of the image sensor, and control the focus drive unit based on the contrast information of each of a plurality of images generated from the number of pulses of the voltage pulses generated within an exposure period of the exposure. An image pickup apparatus having the above autofocus control apparatus also constitutes another aspect of the disclosure. An autofocus control method corresponding to the above autofocus control apparatus also constitutes another aspect of the disclosure. A storage medium storing a program that causes a computer to execute the above autofocus control method also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a block diagram illustrating the configuration of an image pickup apparatus in which the conventional AF control apparatus is used.

FIG. 2 is a block diagram illustrating the configuration of an image pickup apparatus in which an AF control apparatus according to each embodiment is used.

FIG. 3A is a circuit diagram illustrating the configuration of an imaging pixel in each embodiment.

FIG. 3B explains the operation principle of an image sensor in each embodiment.

FIG. 4 is a flowchart illustrating an operation of the conventional image pickup apparatus.

FIG. 5 is a flowchart illustrating an operation of the image pickup apparatus according to each embodiment.

FIG. 6 is a timing chart illustrating the conventional contrast AF operation.

FIG. 7 is a timing chart illustrating a contrast AF operation according to a first embodiment.

FIG. 8 is a timing chart illustrating a contrast AF operation according to a second embodiment.

### DETAILED DESCRIPTION

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure. Corresponding elements in respective figures will be designated by the same reference numerals, and a duplicate description thereof will be omitted.

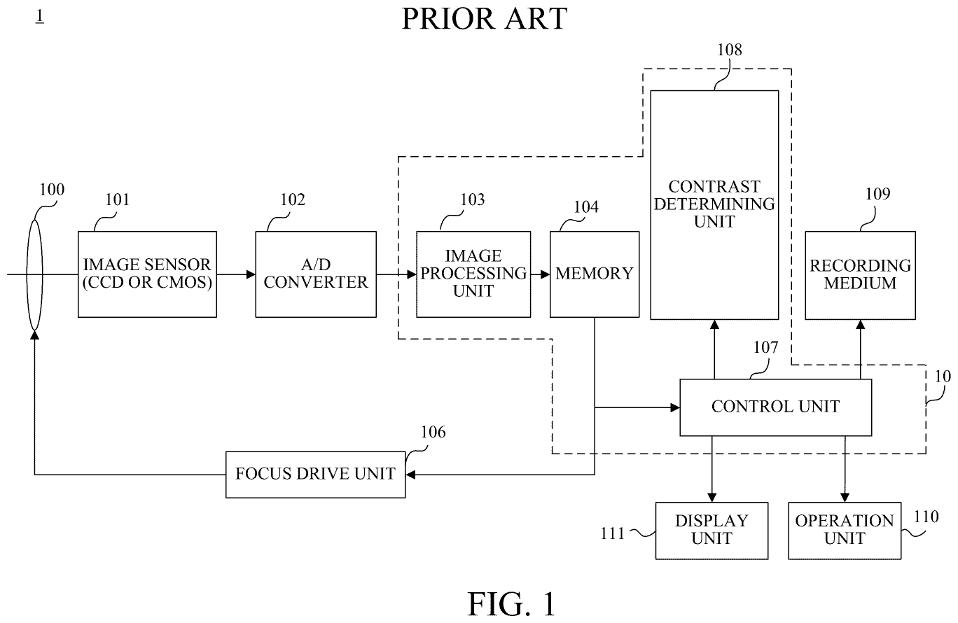

FIG. 1 is a block diagram illustrating the configuration of the conventional image pickup apparatus 1. The image pickup apparatus 1 includes an imaging optical system 100, an image sensor 101, an A/D converter 102, an image processing unit 103, a memory 104, a focus drive unit 106, a control unit 107, a contrast determining unit 108, a recording medium 109, an operation unit 110, and a display unit 111. The image processing unit 103, the memory 104, the control unit 107, and the contrast determining unit 108 constitute an AF control apparatus 10.

The focus drive unit 106 performs focusing for the imaging optical system 100 by driving a focus lens unit, which is at least a part of the imaging optical system 100, in the optical axis direction. The image sensor 101 acquires an optical image of an object formed by the imaging optical system 100. The conventional image sensor 101 includes, for example, a CMOS sensor or a CCD sensor. The A/D converter 102 converts the optical image acquired by the image sensor 101 into digital data. The converted digital data is processed by the image processing unit 103 and stored in the memory 104. The contrast determining unit 108 determines a drive direction of the focus lens unit using the digital data that has been processed by the image processing unit 103 and stored in the memory 104. The control unit 107 controls the focus drive unit 106 based on the result of the contrast determining unit 108 and moves the focus lens unit.

This prior art acquires a plurality of images for AF determination, and determines the contrast at the contrast determining unit 108. The images for focus determination are acquired by reading analog data from the image sensor 101 and then converting the analog data into digital data at the A/D converter 102. At this time, the image sensor 101 once stops exposure. Therefore, in order to acquire the next image for focus determination, the image sensor 101 is to start exposure again. Therefore, in order to determine the contrast by comparing contrast values (contrast information) and drive the focus lens unit, a time is required for the A/D conversion of multiple pieces of data and re-exposure.

The control unit 107 controls the overall operation of the image pickup apparatus 1. The control unit 107 includes a CPU (at least one processor) and executes a program for controlling each component in the image pickup apparatus 1. The control unit 107 also controls the focus drive unit 106 using the result of the correlation calculation output from the image processing unit 103 to perform focusing for the imaging optical system 100. The operation unit 110 is an operation member for the shutter operation and exposure control operation of the image pickup apparatus 1. The display unit 111 displays captured still images and moving images. The display unit 111 also displays a menu screen and the like. The recording medium 109 is a removable recording medium for recording still image data and moving image data.

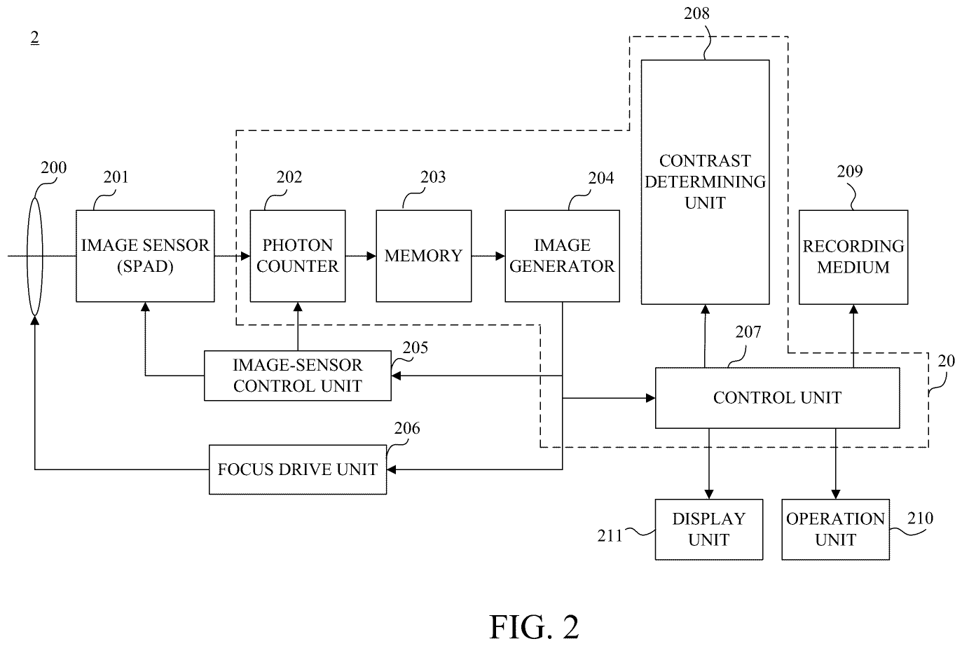

FIG. 2 is a block diagram illustrating the configuration of the image pickup apparatus 2 according to each embodiment. The image pickup apparatus 2 includes an imaging optical system 200, an image sensor 201, a photon counter 202, a memory 203, an image generator 204, an image-sensor control unit 205, a focus drive unit 206, a control unit 207, a contrast determining unit 208, a recording medium 209, an operation unit 210, and a display unit 211. In each embodiment, the photon counter 202, the memory 203, the image generator (at least one processor) 204, the control unit 207, and the contrast determining unit (at least one processor) 208 constitute an AF control apparatus 20.

The focus drive unit 206 performs focusing for the imaging optical system 200 by driving a focus lens unit, which is at least a part of the imaging optical system 200, in the optical axis direction. The memory 203 and the photon counter 202 may be provided inside the image sensor 201.

The image pickup apparatus 2 according to each embodiment is an image pickup apparatus in which a lens apparatus having the imaging optical system 200 and a camera body are integrated with each other, but each embodiment is not limited to this example. The image pickup apparatus 2 may be configured so that a lens apparatus (interchangeable lens) can be attached and detached. In this case, the focus drive unit 206 may be provided on the lens device side.

The image sensor 201 acquires an optical image of an object formed by the imaging optical system 200. The photon counter 202 counts voltage pulses output from each pixel on the image sensor 201 each time one photon enters the pixel (this is called photon counting hereinafter). The number of counted photons (photon counts) is recorded in the memory 203 together with the time when the photon was counted. The image generator 204 generates an image using the voltage pulses output from the image sensor 201. The image sensor 201 is controlled by the image-sensor control unit 205. The image sensor 201 in each embodiment is a so-called photon counting type image sensor having pixels using the avalanche effect (multiplication). For example, each pixel is a Single Photon Avalanche Diode (SPAD) having an avalanche photodiode driven in a Geiger mode. The image sensor 201 further includes a pixel array in which a plurality of pixels are arranged in a matrix (a two-dimensional plane in the row and column directions), and outputs image data from the pixels by sequentially scanning each row.

The control unit 207 controls the overall operation of the image pickup apparatus 2. The control unit 207 includes a CPU (processor), and executes a program for controlling each component in the image pickup apparatus 2. The contrast determining unit 208 calculates a contrast value (contrast information) for each image based on the image output from the image generator 204. The control unit 207 controls the focus drive unit 206 based on the results of the contrast value for each image, and performs focusing for the imaging optical system 200. The recording medium 209 is a removable recording medium for recording still image data and video data. The operation unit 210 is an operation member for the shutter operation and exposure control operation of the image pickup apparatus 2. The display unit 211 displays captured still images and moving images. The display unit 211 also displays a menu screen and the like.

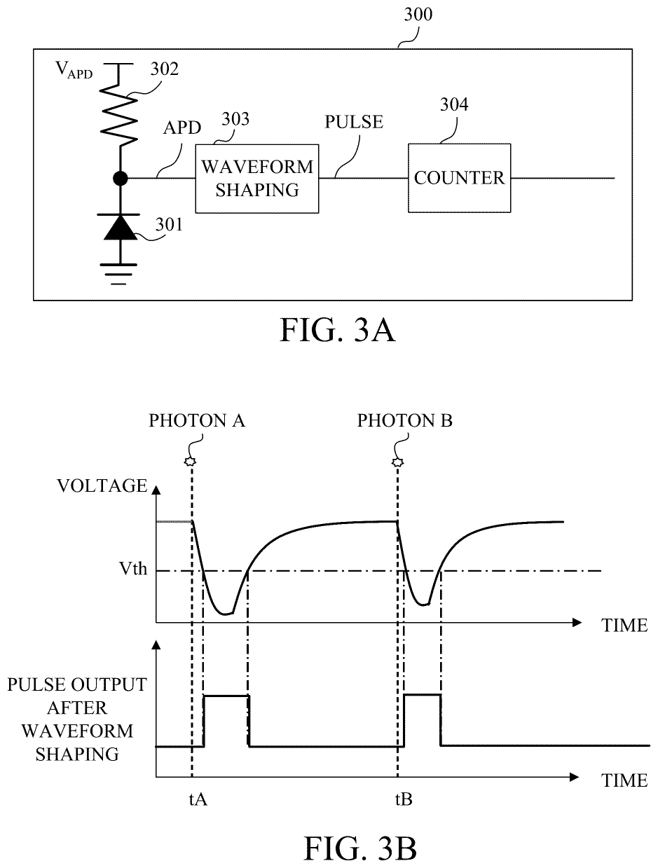

Referring now to FIG. 3A, the configuration of the image sensor 201 will be described in detail. FIG. 3A is a circuit diagram illustrating the configuration of an imaging pixel of the image sensor 201. The imaging pixel circuit (photoelectric converter) 300 of each pixel of the image sensor 201 includes an avalanche photodiode (APD hereinafter) 301, a quench resistor 302, a waveform shaping circuit 303, and a counter 304. The APD 301 can amplify a signal charge amount excited by photons by several to a million times by using the avalanche multiplication phenomenon generated by a strong electric field induced in the pn junction of a semiconductor. The APD 301 can greatly amplify a weak light signal by utilizing the high gain of this avalanche multiplication phenomenon, improving the signal-to-noise ratio relative to the readout noise generated in the readout circuit, and achieving a luminance resolution at the single photon level.

The APD 301 is connected to a reverse bias voltage VAPD via a quench resistor 302, and generates charges by avalanche multiplication when a photon is incident. The generated charges are discharged via the quench resistor 302. In other words, the generation of electric charges by avalanche multiplication and the discharge of electric charges through the quench resistor 302 are repeated according to the number of photons incident on the APD 301. Based on the voltage on the cathode side of the APD 301, in a case where no photons are incident, the voltage is approximately the same as the reverse bias voltage VAPD, and the voltage is reduced by the electric charges generated by the incidence of photons on the APD 301.

The waveform shaping circuit 303 generates a voltage pulse by amplifying and detecting edges of the change in the voltage on the cathode side of the APD 301 caused by the generation and discharge of electric charges according to the incidence of photons. In each embodiment, the APD 301 corresponds to a light receiver configured to convert the light (light beam) incident from the exit pupil of the imaging optical system 200 into a voltage pulse based on the avalanche effect.

The counter 304 as a counter unit counts the number of voltage pulses (number of pulses) output by the waveform shaping circuit 303 for a predetermined time, and outputs the count result as a digital value to the photon counter 202 outside the pixel. In each embodiment, the counter 304 corresponds to a counter that counts the number of voltage pulses generated within the exposure time.

The count result, which is a digital value, is stored in the memory 203 via the photon counter 202. Acquiring the count numbers from a plurality of imaging pixel circuits 300 in a predetermined area on the pixel array can generate an image for AF determination, an image for one frame, or a final image. Each embodiment does not require the A/D conversion in acquiring the image for AF determination. In acquiring a plurality of images for focus determination, the photon count number (pulse number) acquired from the image sensor 201 and photon count information (count information) including the acquisition time of the count number, which is time information associated with the count number, are stored in the memory 203. Adding and subtracting the photon count number at an arbitrary timing while exposure is continued can provide an image for AF determination at an arbitrary timing during the exposure period. For example, calculating a difference between the count number at time t1 and the count number at time t2 (>t1) can provide an image for AF determination at a time corresponding to time t2. An image for AF determination at the time corresponding to time t3 (>t2) may be obtained by a difference between the count number at time t2 and the count number at time t3. Alternatively, the count number at time t2 may be added to or subtracted from a difference between the count number at time t1 and the count number at time t3 to obtain the image for AF determination at the time corresponding to time t3. Therefore, compared to the prior art, the time required for A/D conversion and the time required for re-acquiring the image for AF determination are not required, and each embodiment can achieve high-speed AF. In addition, using the SPAD can achieve highly accurate AF without irradiating active light even in dark places.

FIG. 3B explains the operation principle of the image sensor 201 according to this embodiment. In FIG. 3B, the horizontal axis represents time, and a relationship between the pulse waveform of the output voltage due to avalanche multiplication output from the APD 301 when a photon is incident and a threshold value Vth for determining the incidence of a photon is illustrated. FIG. 3B illustrates the case where a potential capable of applying a reverse bias voltage exceeding the breakdown voltage is supplied to the APD 301. For each of the photon A (time tA) and photon B (time tB) incident on the APD 301, avalanche multiplication occurs to the extent that a pulse waveform that changes beyond the counter threshold value Vth is output, and each pulse is time-resolved. Hence, the incident photons can be counted over time.

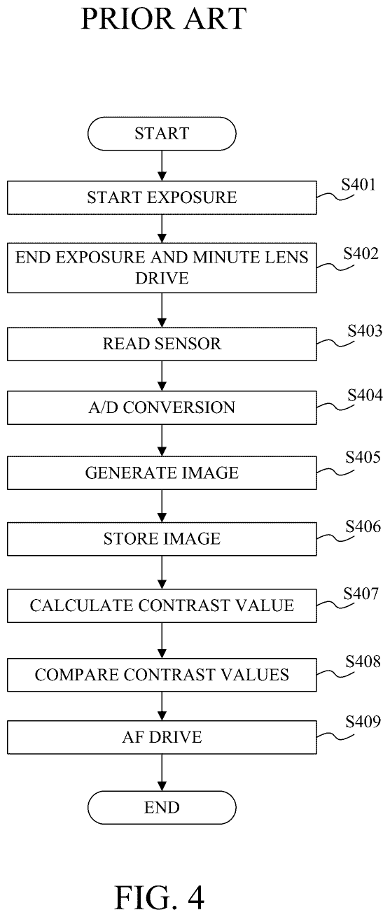

FIG. 4 illustrates a flowchart illustrating the operation from image acquisition to determining contrast and driving the focus lens unit in the conventional image pickup apparatus 1. First, in step S401, the control unit 107 starts exposure of the image sensor 101 in order to acquire an image for AF determination. Thereafter, in step S402, the control unit 107 temporarily ends exposure of the image sensor 101 and minutely drives the focus lens unit to acquire the next image. In step S403, the control unit 107 causes the A/D converter 102 to read analog data from the image sensor 101. In step S404, the control unit 107 causes the A/D converter 102 to convert the analog data into digital data. In step S405, the control unit 107 causes the image processing unit 103 to generate an image. In step S406, the control unit 107 stores the generated image in the memory 104. In step S407, the control unit 107 causes the contrast determining unit 108 to calculate a contrast value from the image stored in the memory 104. The operations from step S401 to step S407 are performed multiple times, and in step S408, the control unit 107 causes the contrast determining unit 108 to compare the contrast values from the plurality of images. In step S409, the control unit 107 controls the focus drive unit 106 to drive the focus lens unit in a direction that increases a contrast value.

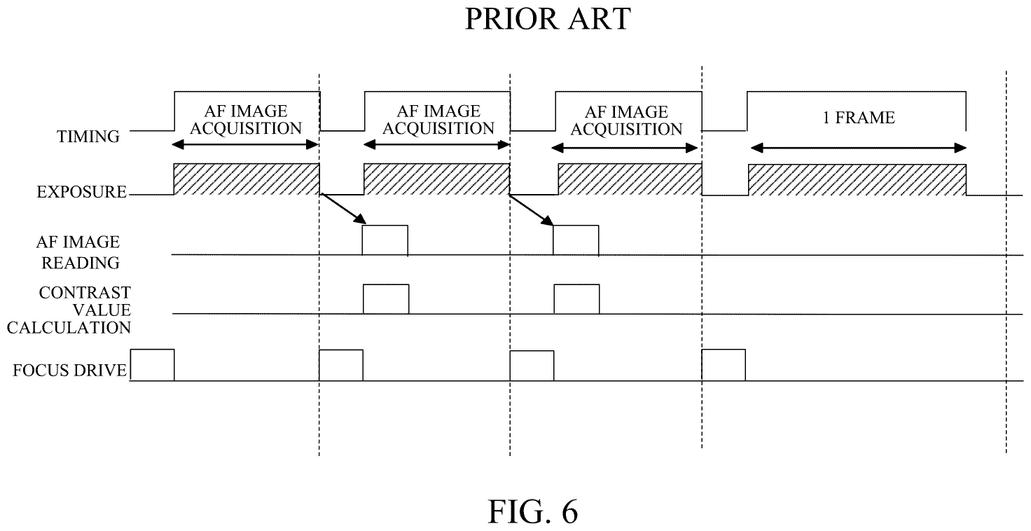

FIG. 6 is a timing chart of the image pickup apparatus 1 of the conventional example. First, exposure is started to obtain an image for AF determination. Thereafter, exposure is once completed, analog data is read from the image sensor, an image for AF determination is generated by A/D conversion, and the contrast value of the image is calculated. Once exposure is completed, the focus lens unit is minutely driven, and when the reading of the first analog data is started, exposure is started again to obtain the next image for AF determination. This operation is repeated a plurality of times to calculate the contrast values of the plurality of images. By comparing the contrast values, the focus lens unit is driven in a direction that increases the contrast value. For live-view display on the screen and for capturing a unit frame of a moving image or a still image, exposure is performed for a predetermined exposure time after the focus lens unit is moved, and a final in-focus image is output.

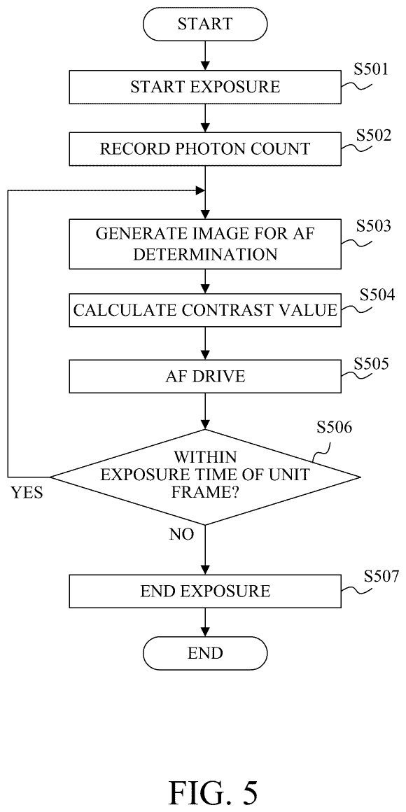

FIG. 5 is a flowchart illustrating the contrast value determination and AF operation in the exposure time of a unit frame of the image pickup apparatus 2 according to this embodiment. First, in step S501, the control unit 207 starts exposure of the image sensor 201. Then, in step S502, the control unit 207 causes the photon counter 202 to count the number of photons incident on each pixel, and records the counted number of photons together with the time in the memory 203. In step S503, the control unit 207 causes the image generator 204 to generate an image for AF determination from the photon count information stored in the memory 203, which includes the photon count number and the acquisition time of that count number. Here, the image generator 204 can generate an image for AF determination at an arbitrary timing during the exposure period by properly adding and subtracting the photon count information at an arbitrary timing. In step S504, the control unit 207 causes the contrast determining unit 208 to calculate a contrast value from the generated image for AF determination. In step S505, the control unit 207 controls the focus drive unit 206 to drive the focus lens unit in a direction that increases a contrast value. In step S506, the control unit 207 determines whether the time is within the exposure time of the unit frame, and in a case where it is within the exposure time of the unit frame, repeats the processing of steps S501 to S505. In step S507, the control unit 207 ends the exposure of the image sensor 201.

### First Embodiment

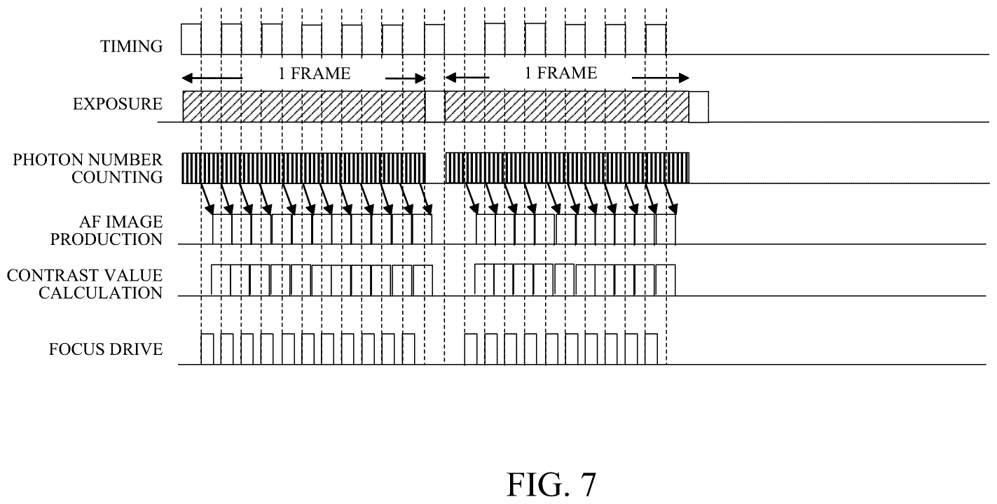

FIG. 7 is a timing chart in a case where a moving image is captured with the image pickup apparatus 2 according to the first embodiment. The first embodiment premises that the moving image is captured while the focus lens unit is always driven back and forth in the optical axis direction to kept in focus on a predetermined object. First, exposure is started to obtain an image for one frame of the moving image. At the same time, photon counting is started to count the number of photons, and the count number of photons is recorded in the memory 203. While the focus lens unit is driven back and forth (reciprocated), an image for AF determination is produced at an arbitrary timing based on the photon count, and the contrast value of the image is calculated. The focus lens unit is driven in the direction that increases the contrast value. Exposure continues during one frame of operation. After one frame of operation is completed, exposure ends once, the photon counter is reset, and exposure is started again to obtain the image of the next frame. As illustrated in FIG. 7, the first embodiment can continuously obtain images for AF determination. Thereby, the object can be tracked at all times, and highly accurate moving image capturing can be achieved.

### Second Embodiment

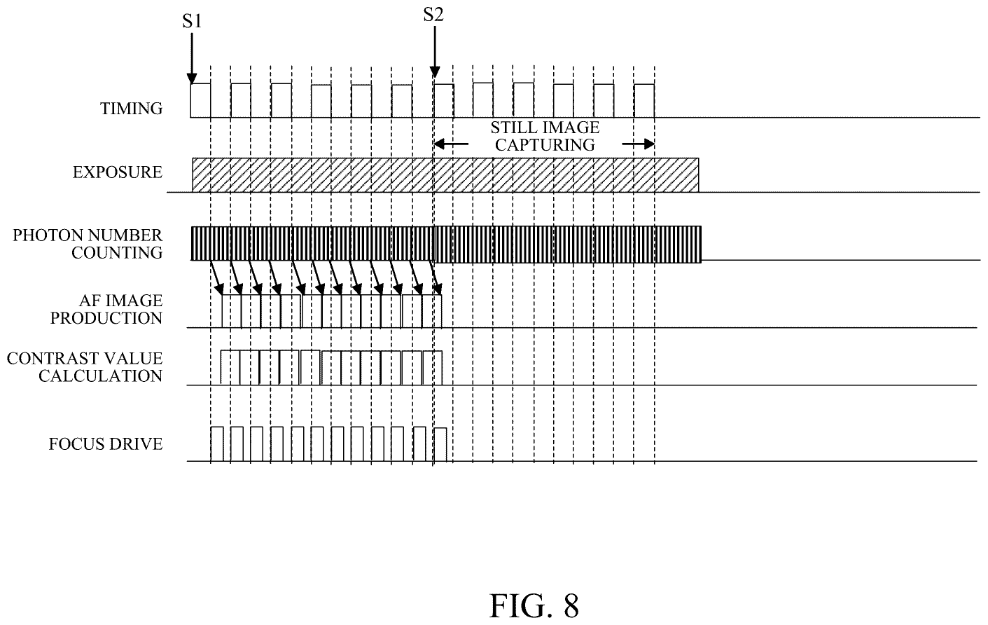

FIG. 8 is a timing chart in a case where still images are captured by the image pickup apparatus 2 according to a second embodiment. The second embodiment presumes that AF control is started when the shutter button of the image pickup apparatus 2 is half-pressed by the user (S1), and then the shutter button is further pressed down to the full-press state (S2), and a still image is acquired. First, exposure starts at the same time as the shutter button of the image pickup apparatus 2 is half-pressed, photon counting is started to count the number of photons, and the photon count number is recorded in the memory 203. While the focus lens unit is driven back and forth (reciprocated) in the optical axis direction, an image for AF determination is produced at an arbitrary timing based on the photon count number, and the contrast value of the image is calculated. The focus lens unit is driven in the direction that increases the contrast value, and finally, the focus lens unit is driven to a position where the contrast value is maximum. Then, when the shutter button is fully pressed (S2), exposure is performed for a predetermined exposure time from the photon count number stored in the memory 203, and a still image that is a final in-focus image is generated. To generate a still image, the number of pulses of voltage pulses (photon count number) generated during the still-image exposure period, excluding an exposure period during which the images for AF determination were generated, is used. A still image may be generated by adding or subtracting an image produced based on the photon count number acquired during the still-image capturing exposure period. During this series of operations, exposure continues.

Each embodiment may satisfy the following inequality (1):

$$0. < m / fT < 1. \qquad ( 1 )$$

where m is an average number of incident photons per pixel on the image sensor 201, and fT is a clock number of the image sensor 201.

Inequality (1) defines the average number of incident photons per pixel m relative to the clock number fT.

A relationship between the count number n per pixel and the average number of incident photons per pixel m will now be described. The count number n per pixel is defined by the following expression using the average number of incident photons m and the clock number fT.

$$n = fT \times ( 1 - Exp ( - m / fT ) )$$

Here, the average number of incident photons per pixel m is defined by the following expression.

$$m = S \times Lf \times t \\ Lf = ( R \times T / 4 F \hat{} 2 ) \times Le$$

Here, S is sensor sensitivity, Lf is sensor surface illuminance, t is an exposure time, R is object reflectance, T is lens transmittance, and F is an F-number (aperture value) of the lens. From inequality (1), the smaller the value of the average number of incident photons per pixel m relative to the clock number fT is, the more linearity can be satisfied.

In a case where the value becomes higher than the upper limit of inequality (1), a relationship between the number of incident photons m and the counted value will no longer be linear. In a case where the value becomes lower than the lower limit of inequality (1), the measurement error will increase due to the influence of noise components. The determination of linearity is not limited to the count of the number of photons, and the determination criteria may be set based on the object illuminance and the luminance value of the image.

Inequality (1) may be replaced with inequality (1a) below:

$$0.01 < m / fT < 0.8 \qquad ( 1 a )$$

Inequality (1) may be replaced with inequality (1b) below:

$$0.05 < m / fT < 0.5 \qquad ( 1 b )$$

### OTHER EMBODIMENTS

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has described example embodiments, it is to be understood that the disclosure is not limited to the example embodiments. The scope of the following claims is to be accorded the broadest interpretation so as to encompass all such modifications and equivalent structures and functions.

Each embodiment can provide an AF control apparatus that can perform focus detection at a higher speed and with a higher degree of accuracy than the conventional method in performing AF using a contrast detection method.

What is claimed is:

1. An autofocus control apparatus comprising:
at least one processor that executes instructions to control a focus drive unit configured to drive a focus lens unit that is at least a part of an imaging optical system based on contrast information obtained from an image sensor that includes a plurality of photoelectric converters arranged on a two-dimensional plane, each of the plurality of photoelectric converters including a light receiver configured to convert light incident from the imaging optical system into a voltage pulse, and a counter configured to count the number of the voltage pulses,
wherein the at least one processor is configured to:
cause the focus drive unit to reciprocate the focus lens unit while continuing exposure of the image sensor, and
control the focus drive unit based on the contrast information of each of a plurality of images generated from the number of pulses of the voltage pulses generated within an exposure period of the exposure.

2. The autofocus control apparatus according to claim 1, wherein the light receiver is an avalanche photodiode that is provided in each pixel on the image sensor and driven in a Geiger mode.

3. The autofocus control apparatus according to claim 1, further comprising a memory storing the number of pulses of the voltage pulses generated within the exposure period of the exposure.

4. The autofocus control apparatus according to claim 1, wherein the at least one processor is configured to generate the plurality of images using the number of pulses of the voltage pulses generated within the exposure period of the exposure.

5. The autofocus control apparatus according to claim 4, wherein the at least one processor is configured to generate the plurality of images using count information including the number of pulses of the voltage pulses generated within the exposure period of the exposure and time information associated with the number of pulses.

6. The autofocus control apparatus according to claim 5, wherein the at least one processor is configured to generate the plurality of images by adding and subtracting the count information.

7. The autofocus control apparatus according to claim 4, wherein the at least one processor is configured to generate an in-focus image exposed for a predetermined exposure time using the number of pulses of the voltage pulses generated within the exposure period of the exposure.

8. The autofocus control apparatus according to claim 7, wherein the at least one processor is configured to generate the in-focus image exposed for the predetermined exposure time using the number of pulses of the voltage pulses generated within the exposure period of the exposure excluding an exposure period during which the plurality of images were generated.

9. The autofocus control apparatus according to claim 7, wherein the exposure period for generating each of the plurality of images is shorter than the predetermined exposure time for generating the in-focus image.

10. The autofocus control apparatus according to claim 4, wherein the at least one processor is configured to generate the plurality of images continuously.

11. The autofocus control apparatus according to claim 1, wherein the following inequality is satisfied:
0.0<m/fT<1.0
where m is an average number of incident photons per pixel on the image sensor, and fT is a clock number of the image sensor.

12. The autofocus control apparatus according to claim 1, wherein the plurality of images are images for focus determination.

13. The autofocus control apparatus according to claim 1, wherein the at least one processor is configured to performs focusing for the imaging optical system by controlling the focus drive unit.

14. The autofocus control apparatus according to claim 1, wherein the at least one processor is configured to calculate the contrast information of each of the plurality of images.

15. The autofocus control apparatus according to claim 1, wherein the light receiver converts the light incident from the imaging optical system into the voltage pulse based on an avalanche effect.

16. An image pickup apparatus comprising:
an image sensor that includes a plurality of photoelectric converters arranged on a two-dimensional plane; and
the autofocus control apparatus according to claim 1,
wherein each of the photoelectric converters includes:
a light receiver configured to convert light incident from an imaging optical system into a voltage pulse, and
a counter configured to count the number of the voltage pulses.

17. The image pickup apparatus according to claim 16, further comprising the focus drive unit configured to drive the focus lens unit.

18. An autofocus control method comprising:
controlling a focus drive unit configured to drive a focus lens unit that is at least a part of an imaging optical system based on contrast information obtained from an image sensor that includes a plurality of photoelectric converters arranged on a two-dimensional plane, each of the plurality of photoelectric converters including a light receiver configured to convert light incident from the imaging optical system into a voltage pulse, and a counter configured to count the number of the voltage pulses,
wherein the controlling the focus drive unit includes:
causing the focus drive unit to reciprocate the focus lens unit while continuing exposure of the image sensor, and
controlling the focus drive unit based on the contrast information of each of a plurality of images generated from the number of pulses of the voltage pulses generated within an exposure period of the exposure.

19. A storage medium storing a program that causes a computer to execute the autofocus control method according to claim 18.
